(19) United States
(12) Patent Application Publication
(10) Pub. No.: US 2025/0153418 A1
(43) Pub. Date: May 15, 2025

(54) METHOD FOR CONTROLLING A CONTAINER TREATMENT SYSTEM, AND DEVICE COMPRISING A CONTAINER TREATMENT SYSTEM AND A CONTROL DEVICE FOR CARRYING OUT THE METHOD

(71) Applicant: Krones AG, Neutraubling (DE)

(72) Inventors: Benedikt BOETTCHER, Bruckmühl (DE); Markus ZOELFL, Metten (DE); Andreas STEINER, Wenzenbach (DE); Robert AUST, Illkofen (DE)

(21) Appl. No.: 18/949,384

(22) Filed: Nov. 15, 2024

(30) Foreign Application Priority Data
Nov. 15, 2023 (DE) 10 2023 131 854.3

(51) Int. Cl. B29C 49/78; B29C 49/06; B29L 31/00

(52) U.S. Cl. CPC B29C 49/786; B29C 49/06; B29C 2049/7861; B29C 2049/78715; B29C 2049/78755; B29L 2031/712

(57) ABSTRACT

The disclosure relates to a method for controlling a container treatment system, for example a blow molding machine, for producing containers from preforms, wherein the method comprises: providing a main agent comprising a plurality of sub-agents, each sub-agent being assigned to a container type or a preform, a target parameter set for controlling the container treatment system and a group of target values for a controlled variable being provided for each sub-agent; carrying out a determination of a characteristic of a preform; evaluating a result of the determination and automatically selecting a corresponding sub-agent from the plurality of sub-agents based on the evaluation; and using the corresponding sub-agent for controlling the container treatment system. The disclosure further relates to a device comprising a container treatment system and a control device for carrying out the method.

### CROSS REFERENCE TO RELATED APPLICATION

The present application claims priority to German Patent Application No. 10 2023 131 854.3 filed on Nov. 15, 2023. The entire contents of the above-listed application are hereby incorporated by reference for all purposes.

### Technical Field

The disclosure relates to a method for controlling a container treatment system and to a device comprising a container treatment system and a control device for carrying out the method.

### BACKGROUND

### Prior Art

It is known that a separate statistical design of experiments (DoE) must be carried out for each combination of PET preform and PET container. The statistical design of experiments can provide the basis for agent training for the corresponding combination of PET preform and PET container. The agent can be trained and learn all parameter settings for the blow molding machine and their effects on this corresponding combination of PET preform and PET container for later use.

### SUMMARY

### Object

The object of the disclosure is to provide a method for controlling a container treatment system and a device comprising a container treatment system and a control device for carrying out the method, which can allow efficient use of an agent for parameter setting of a container treatment system.

### Solution

The object is achieved by the method for controlling a container treatment system and the device comprising a container treatment system and a control device for carrying out the method as described herein.

The method according to the disclosure for controlling a container treatment system for producing containers, for example PET containers or containers comprising fibers, from preforms, for example PET preforms or preforms comprising fibers, comprises: providing a main agent comprising a plurality of sub-agents, each sub-agent being assigned to a container type or a preform, a target parameter set for controlling the container treatment system and a group of target values for a controlled variable being provided for each sub-agent; carrying out a determination of a characteristic of a preform; evaluating a result of the determination and automatically selecting a corresponding sub-agent from the plurality of sub-agents based on the evaluation; and using the corresponding sub-agent for controlling the container treatment system.

The container treatment system can be or comprise a device for producing preforms, for example an injection molding machine, a heating device for preforms, a stretch blow molding machine, a filler and/or other units of the complete line, such as rinsers or labelers.

The preforms can be produced using a preform manufacturing machine, such as an injection molding machine.

A controlled variable may include a wall thickness, a light transmission and/or a value characteristic of a container base geometry.

For light transmission, a transmission value and/or transmittance for electromagnetic radiation can be measured. For example, light or infrared can be used. The wall thickness can be a wall thickness of the container.

A sub-agent can be considered to be a program in artificial intelligence (AI) that can make decisions or perform a service based on the result of the infrared absorption measurement.

The sub-agent can independently control the container treatment system. To select the correct sub-agent, one or more characteristics of the preforms and/or containers can be used.

AI can control the heating and blowing process. For example, light transmittance as measured quantities of the containers produced can be adjusted to target values by the sub-agent through control decisions. A pre-blowing time can be used for control; for example, a pre-blowing pressure and/or heating zone settings can also be used.

By providing a plurality of sub-agents in the main agent, a flexible control of the container treatment system for different preforms is possible, which can be taken into account by corresponding sub-agents.

A main agent can be viewed as a plurality of sub-agents, wherein a sub-agent can be selected from the plurality, which sub-agent is best adapted to one or more characteristics of the preforms and/or the containers.

The containers can be bottles.

The determination of the characteristic may comprise determining a single characteristic of the preform or multiple characteristics of the preform. When determining multiple characteristics, one type of measurement or different types of measurements can be used. The type of measurement can be an infrared absorption measurement or a camera recording (image, pictures or video).

The determination of the characteristics of a preform can be carried out using a measurement such as an infrared absorption measurement. In addition, a measurement can be carried out using a camera that can capture one or more images or a sequence of images (such as a video). The determination of the characteristics of the preform can be carried out online or offline.

By using the corresponding sub-agent for controlling the container treatment system, an optimal result can be achieved for the container produced from the preform in the container treatment system for the preform for which the characteristic was determined.

The result of the determination of the characteristics of the preform can comprise at least one of:
a composition of the preform, such as a proportion of recycled material and/or a proportion of new material,
a geometric shape of the preform,
a code on the preform, wherein for example the code has been arranged on the preform in an injection mold for producing the preform,
a barcode on the preform, wherein the barcode allows, for example, a conclusion to be drawn about the batch from which the preform originates,
a manufacturer of the preform,
an infrared absorption level of the preform,
a moisture content of the preform,
a mass of the preform,
temperatures at various points on the preform.

An infrared absorption measurement can be used, for example, to determine the composition of the preform as a characteristic.

The geometric shape and/or the code and/or the barcode can be determined using a camera. The manufacturer of the preform can be retrieved from a process database in which the manufacturer of a preform can be stored.

The determination of the characteristics of a preform can be carried out in a preform feeding device and/or before heating the preform. The feeding device may comprise a downwardly inclined guide trough for the preforms. For example, the determination of the characteristics of a preform can be carried out in a feed star, for example in a sawtooth star, in front of an oven.

Alternatively, the determination of the characteristics of a preform can be carried out in a machine for producing the preforms, for example in an injection molding machine, or between the machine for producing the preforms and a stretch blow molding machine.

A container type can be defined by at least one of:
a volume size of the container,
a weight of the container,
a composition of the container, such as a proportion of recycled material and/or a proportion of new material,
a geometric shape of the container,
a type of closure to be placed on the container,
a product to be filled into the container,
a label to be placed on the container.

The infrared absorption measurement of a preform can be carried out by means of an infrared absorption value sensor. In addition, the moisture content of a preform can be measured by means of infrared technology.

At least two of the sub-agents can each have been created based on a statistical design of experiments (DoE).

A further sub-agent can be created by combining at least two of the statistical designs of experiments and added to the majority of sub-agents.

By combining different statistical designs of experiments, it can be achieved that a new statistical design of experiments only needs to be carried out for unknown aspects of a new container type. For example, the main agent or sub-agents can be used in Artificial Intelligence (AI) that not only controls a stretch blow molding process, but also the preform manufacturing process in a preform manufacturing machine. The preform manufacturing machine can comprise an injection molding machine, and the manufacturing process can be an injection molding process.

The target parameter set can comprise at least one of:
a pre-blowing start time,
a blowing pressure or a time dependency of the blowing pressure,
a stretching time of a stretching process of a preform with a stretching rod,
a temperature profile of an oven,
a given target value profile of a wall thickness and/or light transmission.

The oven may be or comprise an IR oven (infrared oven), a microwave oven or a laser oven. The oven can be designed to heat the preforms.

Target parameters of the oven which may be included in the target parameter set can include:
IR emitter power (in the IR oven),
cooling in the oven (in the IR oven),
positions of the slide elements (in the microwave oven).

Furthermore, a device comprising a container treatment system and a control device for carrying out the method as described above or below is provided.

The device may further comprise a feeding device for preforms. The feeding device may comprise a downwardly inclined guide trough for the preforms.

The device may further comprise an infrared absorption value sensor. The infrared absorption value sensor can be used to determine the characteristics of a preform.

The infrared absorption value sensor can be arranged in the feeding device.

The device may further comprise a camera. The camera can be used to determine the characteristics of a preform.

The device may further comprise a moisture content sensor.

The moisture content sensor can be arranged in the feeding device.

### BRIEF DESCRIPTION OF THE DRAWINGS

The accompanying FIGURE shows, by way of example, aspects and/or embodiments of the disclosure for better understanding and illustration. In the drawing:

FIG. 1 is a block diagram of a method for controlling a blow molding machine (7) for producing containers from preforms.

### DETAILED DESCRIPTION OF THE DRAWINGS

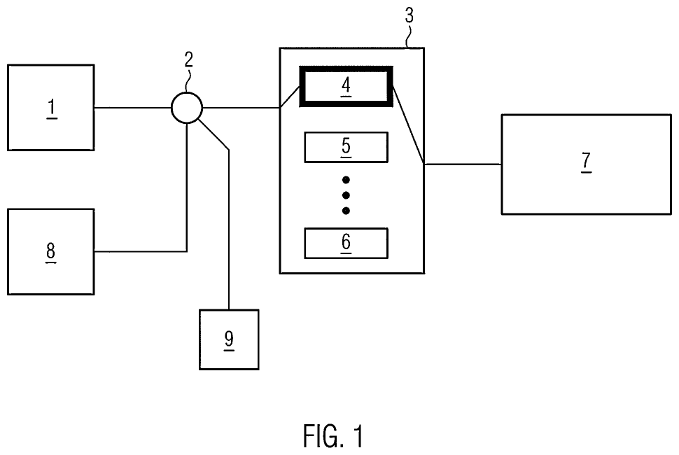

FIG. 1 shows a block diagram of a method for controlling a container treatment system, which is designed here, by way of example, as a blow molding machine 7 for producing containers from preforms. The system may include a control device, for example in the blow molding machine 7 or a separate component, with a processor and memory holding instructions and logic, along with sensor (such as the camera) and actuators, for carrying out the operations described herein.

An infrared absorption value sensor 1 and a camera 8 are provided for determining a characteristic of a preform to be fed to the blow molding machine 7 for producing a container. The camera 8 can capture one or more images or an image sequence (such as a video) of the preform or at least a part thereof. A characteristic can be determined by the infrared absorption value sensor 1 or by the camera 8. When determining multiple characteristics, the infrared absorption value sensor 1 and/or the camera 8 can be used. The manufacturer of the preform can also be determined, for example by retrieving corresponding data from a process database 9 in which manufacturers of preforms can be stored.

Therefore, one characteristic of the preform can be determined, but multiple characteristics can also be determined. The result 2 of the determination of the characteristics is evaluated in order to automatically select a corresponding sub-agent 4, 5, 6 based on the characteristics. By means of the infrared absorption value sensor 1, a characteristic such as a composition of the preform, such as a proportion of recycled material and/or a proportion of new material, can be determined. By means of the camera 8, a characteristic—such as a geometric shape of the preform, a code on the preform, where for example the code was arranged on the preform in an injection mold for producing the preform, and/or a barcode on the preform, where for example the barcode allows a conclusion to be drawn about a batch from which the preform originates—can be determined.

In order to be able to select the corresponding sub-agent 4, 5, 6, i.e. a sub-agent 4, 5, 6 that comes closest to the characteristic, the result of the determination is fed to a main agent 3 which comprises a plurality of sub-agents 4, 5, 6. As indicated by the dots, the main agent 3 can also comprise more than the three sub-agents 4, 5, 6 shown. Each of the sub-agents 4, 5, 6 is assigned to a container type, whereby a target parameter set for controlling the blow molding machine 7 is provided for each sub-agent 4, 5, 6. The container type may be indicated by a volume size of the container, a weight of the container, a composition of the container, such as a proportion of recycled material and/or a proportion of new material, a geometric shape of the container, a type of closure to be placed on the container, a product to be filled into the container and/or a label to be placed on the container. The container type can be determined based on the result 2. The result 2 together with the characteristics of the preform may be required to select a suitable target parameter set for controlling the blow molding machine 7, which can be stored in one of the sub-agents 4, 5, 6. The characteristics of the containers, as well as the characteristics of the preforms, can determine the correct sub-agent. Thus, the characteristics of the preform and the container can together determine the correct sub-agent.

In FIG. 1, the first sub-agent 4 is automatically selected based on the result; this is indicated by the thicker line of the box, which is intended to represent the first sub-agent 4.

The first sub-agent 4 is used for controlling the blow molding machine 7. The target parameter set of the first sub-agent 4 can comprise a pre-blowing start time and/or a blowing pressure or a time dependency of the blowing pressure and/or a stretching time of a stretching process of a preform with a stretching rod. The target parameter set is then used for producing the container from the preform in the blow molding machine 7. Thus, a target parameter set suitable for the preform is used in order to obtain a desired container as the end product after production in the blow molding machine 7.

1. A method for controlling a container treatment system for producing containers from preforms, wherein the method comprises:
providing a main agent comprising a plurality of sub-agents, each sub-agent being assigned to a container type or a preform, a target parameter set for controlling the container treatment system and a group of target values for a controlled variable being provided for each sub-agent,
carrying out a determination of a characteristic of a preform,
evaluating a result of the determination and automatically selecting a corresponding sub-agent from the plurality of sub-agents based on the evaluation,
using the corresponding sub-agent for controlling the container treatment system.

2. The method according to claim 1, wherein the result of the determination of the characteristics of the preform comprises at least one of:
a composition of the preform, such as a proportion of recycled material and/or a proportion of new material,
a geometric shape of the preform,
a code on the preform,
a barcode on the preform, wherein the barcode allows,
a manufacturer of the preform,
an infrared absorption level of the preform,
a moisture content of the preform,
a mass of the preform,
temperatures at various points on the preform.

3. The method according to claim 2, wherein the determination of the characteristics of the preform is carried out in a feeding device of the preform and/or before heating the preform.

4. The method according to claim 1, wherein a container type is defined by at least one of:
a volume size of the container,
a weight of the container,
a composition of the container, such as a proportion of recycled material and/or a proportion of new material,
a geometric shape of the container,
a type of closure to be placed on the container,
a product to be filled into the container,
a label to be placed on the container.

5. The method according to claim 1, wherein the infrared absorption measurement of a preform is carried out by means of an infrared absorption value sensor.

6. The method according to claim 1, wherein at least two of the sub-agents have each been created based on a statistical design of experiments.

7. The method according to claim 6, wherein a further sub-agent is created by combining at least two of the statistical designs of experiments and added to the plurality of sub-agents.

8. The method according to claim 1, wherein the target parameter set comprises at least one of:
a pre-blowing start time,
a blowing pressure or a time dependency of the blowing pressure,
a stretching time of a stretching process of a preform with a stretching rod,
a temperature profile of an oven,
a given target value profile of a wall thickness and/or light transmission.

9. A device comprising a container treatment system, and a control device for carrying out the method according to claim 1.

10. The device according to claim 9, further comprising a feeding device for preforms.

11. The device according to claim 9, further comprising an infrared absorption value sensor.

12. The device according to claim 10, wherein the infrared absorption value sensor is arranged in the feeding device.

13. The device according to claim 9, further comprising a camera.

14. The device according to claim 10, further comprising a moisture content sensor.

15. The device according to claim 14, wherein the moisture content sensor is arranged in the feeding device.

16. The method according to claim 1, wherein the container treatment system is a blow molding machine for producing containers.

17. The method according to claim 16, wherein the containers are PET containers or containers comprising fibers.

18. The method according to claim 17, wherein the preforms are PET preforms or preforms comprising fibers.

19. The method according to claim 16, wherein carrying out the determination of the characteristic of the preform is with a measurement including an infrared absorption measurement.

20. The method according to claim 2, wherein the code has been arranged on the preform in an injection mold for producing the preform, and wherein the barcode allows a conclusion to be drawn about a batch from which the preform originates.
